(19) United States
(12) Patent Application Publication
(10) Pub. No.: US 2022/0195550 A1
(43) Pub. Date: Jun. 23, 2022

(54) AIR-HARDENED MACHINE COMPONENTS

(71) Applicant: Caterpillar Inc., Peoria, IL (US)

(72) Inventors: Matthew Thomas Kiser, Peoria Heights, IL (US); Lindsey S. Cavanaugh, Chillicothe, IL (US); Thomas Marshall Congdon, Dunlap, IL (US); Susan Marie Graham, Morton, IL (US); Tianjun Liu, Edwards, IL (US); Mark David Veliz, Metamora, IL (US); Thomas John Yaniak, Peoria, IL (US)

(73) Assignee: Caterpillar Inc., Peoria, IL (US)

(21) Appl. No.: 17/133,251

(22) Filed: Dec. 23, 2020

(51) Int. Cl. C21D 9/04; C21D 8/00; B62D 55/205; C21D 6/00; C21D 1/84; C21D 7/13; C22C 38/02; C22C 38/04

(52) U.S. Cl. CPC C21D 9/04; C21D 8/005; B62D 55/205; C21D 6/005; C21D 6/008; C21D 2211/001; C21D 7/13; C22C 38/02; C22C 38/04; C21D 2211/002; C21D 2261/00; C21D 1/84

(57) ABSTRACT

An example track shoe, cutting edge, or other component of a machine is formed in a heated process, such as hot-rolling followed by air-hardening. The air-hardening process involves cooling the component by flowing air over the component (e.g., air cooling), such that the component is cooled at a controlled rate. During the air-cooling process, such as in the range of about 250° C. to about 1100° C., the component may be machined, such as by shearing, punching, drilling, etc. The machining may form the final shape of the component. As the air-hardening process is completed, and the component approaches room temperature, the component may have at least 5% bainitic crystal composition, and as high as greater than 80% bainitic crystal composition, resulting in relatively high hardness and fracture toughness. The final track shoe may have a hardness between about 40 HRC and 55 HRC.

### TECHNICAL FIELD

The present disclosure relates to machine components that are hardened for improved wear performance. More specifically, the present disclosure relates to machine components that are air-hardened.

### BACKGROUND

Track-type and other machines are in widespread use in construction, mining, forestry, and other similar industries. The undercarriage of a track-type machines utilizes track assemblies, rather than wheels, to provide ground-engaging propulsion. Such track assemblies may be preferred in environments where creating sufficient traction is problematic, such as those frequently found in the industries identified above. Specifically, rather than rolling across a work surface on wheels, track-type machines utilize one or more track assemblies that include an endless loop of coupled track links defining outer surfaces, which support ground-engaging track shoes, and inner surfaces that travel around one or more rotatable track-engaging elements, such as, drive sprockets, idlers, tensioners, and rollers, for example. Additionally, machines, such as track-type machines or other types of machines, may include ground-engaging tools, such as cutting edges that are used to move, break, and/or redistribute dirt, asphalt gravel, and/or other materials.

During operation, the track shoes and/or other components of the track chain assembly, as well as ground-engaging tools, such as cutting edges may experience excessive abrasion, loading, and/or general wear and tear. Therefore, these components may require abrasion resistance with increased hardness to endure abrasive conditions that may be imposed on the components, such as track shoes and cutting edges. Similarly, other components of the track chain may also be prone to high levels of abrasion and made to endure high loads. As a result, components of the track chain assembly may be manufactured with a hardness level to reduce the amount of wear during use. Without sufficient hardness, components such as the track shoes, cutting edges, and bushings may fail to provide sufficient wear resistance during use. However, the hardening of these track components may be a time consuming, laborious, and costly process. For example, manufacture of these components may involve a reheat and quench step that is energy-intensive, expensive, and time-consuming.

An example of producing track shoes is described in Chinese Pat. Application No. 1,112,355,359 (hereinafter referred to as the '359 reference), where steel is subjected to an austenitizing process at high temperature, followed by isothermal quenching in a salt bath, and then air-cooling. These various processes may achieve greater hardness of the track shoes than without these processes. However, these steps, each with its own thermal energy requirements, can result in added cost and time for producing the track shoes. Additionally, in the multi-step rehardening process described in the '359 reference, additional materials may be used, such as salt baths for quenching. In addition to increased cost and processing time, this may increase the number of variables that need to be controlled, and thus, reduce the robustness of the overall manufacturing process.

Examples of the present disclosure are directed toward overcoming the deficiencies described above.

### SUMMARY

In an example of the disclosure, a method of manufacturing a machine component includes forming the machine component using steel heated to a temperature greater than 800° C. and cooling the machine component by directing air onto the machine component to form at least 5% bainite crystal structure in the machine component. The method further includes machining the machine component while cooling the machine component.

In another example of the disclosure, a machine includes at least one component including at least one of a track shoe or a cutting edge. The at least on component includes a first surface and a second surface opposing the first surface, a first edge defining a first end of the at least one component, the first end extending from the first surface to the second surface, and a second edge defining a second end of the at least one component, the second end opposing the first end, the second end extending from the first surface to the second surface. The at least one component further includes a third edge that defines a punchout hole extending from the first surface to the second surface, wherein the at least one component comprises at least approximately 5% bainite crystal structure and a hardness in a range of 40 HRC to 55 HRC.

In yet another example of the disclosure, a track chain assembly includes a plurality of track shoes, a plurality of links, and a plurality of bushings, wherein at least one of the plurality of track shoes, the plurality of links, and the plurality of bushings is formed by hot-rolling steel, the steel having carbon in a range of approximately 0.2% and approximately 0.4% by weight, manganese in a range of approximately 0.1% and approximately 2% by weight, and silicon in a range of approximately 0.1% and approximately 2% by weight. The at least one of the plurality of track shoes, the plurality of links, and the plurality of bushings is formed further by air-cooling the at least one of the plurality of track shoes, the plurality of links, and the plurality of bushings for a period of time; and machining the at least one of the plurality of track shoes, the plurality of links, and the plurality of bushings, during the period of time and at a temperature in a range of approximately 300° C. and approximately 1100° C.

### BRIEF DESCRIPTION OF DRAWINGS

FIG. 1 is a schematic illustration of an example machine with one or more components formed according to examples of the disclosure.

FIG. 2 is a schematic illustration of an example track shoe associated with a track chain assembly of the example machine depicted in FIG. 1, according to examples of the disclosure.

FIG. 3 is a schematic illustration of an example portion of a track chain of the machine depicted in FIG. 1, according to examples of the disclosure.

FIG. 4 is a schematic illustration of an example cutting edge associated with the example machine depicted in FIG. 1, according to examples of the disclosure.

FIG. 5 is a flow diagram depicting an example method for forming an example component of the machine depicted in FIG. 1, according to examples of the disclosure.

FIG. 6 is a flow diagram depicting another example method for forming an example component of the machine depicted in FIG. 1, according to examples of the disclosure.

FIG. 7 is a chart depicting a temperature profile for forming an example component of the machine depicted in FIG. 1, according to examples of the disclosure.

### DETAILED DESCRIPTION

Wherever possible, the same reference numbers will be used throughout the drawings to refer to the same or like parts.

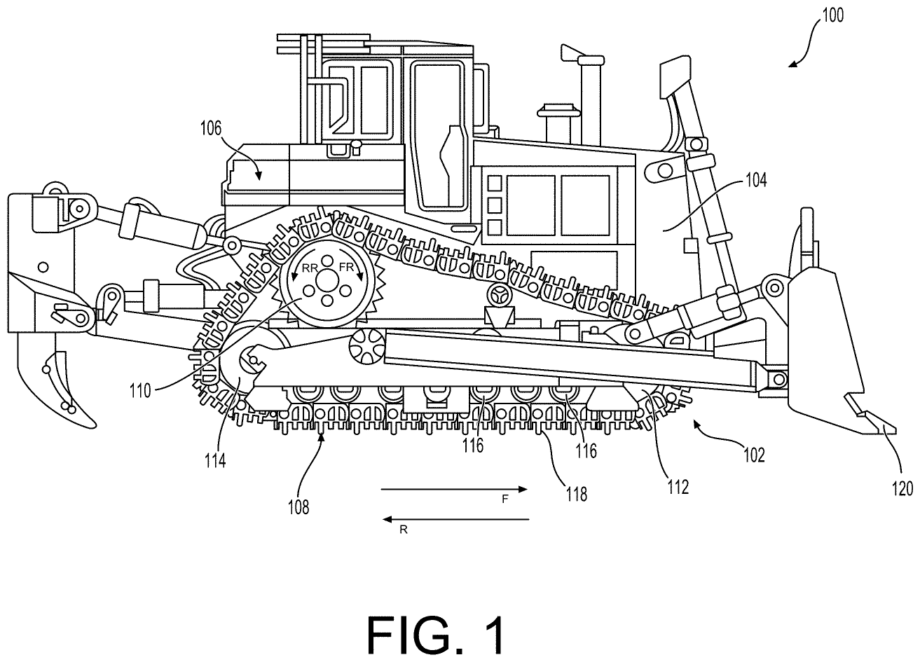

FIG. 1 is a schematic illustration of an example machine 100 with one or more components formed according to examples of the disclosure. The machine 100, depicted as a track-type machine, includes a track-type undercarriage 102. The machine 100 may also be referenced herein interchangeably as a track-type machine 100 and/or machine 100. In other examples, the machine 100 may be any suitable machine with a track-type undercarriage 102, such as, a dozer, loader, excavator, paver, combine, tank, backhoe, drilling machine, trencher, or any other on-highway or off-highway vehicle.

The machine 100 includes a frame 104 having a first track chain assembly 108 disposed on a first side 106 thereof, and a second track chain assembly (not shown) disposed on a second side (not shown) thereof. The second side is in opposing relationship to the first side 106. Together, the track chain assemblies are adapted to engage the ground, or other surface, to propel the machine 100 in a backward and/or forward direction.

It should be appreciated that the track assemblies of the machine 100 may be similar and, further, may represent mirror images of one another. As such, only the first track chain assembly 108 will be described herein. It should be understood that the description of the first track chain assembly 108 may be applicable to the second track chain assembly, as well. Other examples, in accordance with the disclosure, may include more than two track chain assemblies 108. Thus, the apparatus, systems, and methods, as disclosed herein, apply to any suitable track-type machine, or variations thereof. Additionally, the disclosed components of the track-type machine 100 and the mechanism of formation thereof, as discussed herein, may also apply to other systems, such as non-track type machines and/or other mechanical systems.

With continuing reference to FIG. 1, the first track chain assembly 108 extends around a plurality of rolling elements such as a drive sprocket 110, a front idler 112, a rear idler 114, and a plurality of track rollers 116. The track chain assembly 108 includes a plurality of ground-engaging track shoes 118 for engaging the ground, or other surface, and propelling the machine 100.

During typical operation of the undercarriage 102, the drive sprocket 110 is driven, such as by an engine, in a forward rotational direction FR to drive the track chain assembly 108, and thus the machine 100, in a forward direction F, and in a reverse rotational direction RR to drive the track chain assembly 108, and thus the machine 100, in a reverse direction R. The drive sprockets 110 of the undercarriage 102 can be independently operated to turn the machine 100.

The undercarriage 102 and track chain assembly 108 may include a variety of other components, as described herein. Due to the harsh operating environments and the loads put on various components of the track chain assembly 108, it is desirable to improve material properties of the various components of the track chain assembly 108 to improve the usable life of those components.

The machine 100 may also include a cutting edge 120 for moving, breaking, and/or redistributing dirt, asphalt gravel, and/or other materials. For example, a cutting edge 120 may be disposed on any suitable machine 100 such as any suitable track-type machine or non-track-type machines. Machines 100 that include a cutting edge 120 may include, for example, motor graders, dozers, scrapers, or the like. The cutting edge 120, like the track shoes 118, may be subject to harsh operating environments with high frictional and/or abrasive wear conditions. Thus, it is desirable to improve material properties, such as hardness, of the cutting edges 120 to improve their usable life.

While the machine 100 is illustrated in the context of a track-type machine, it should be appreciated that the present disclosure is not thereby limited, and that a wide variety of other machines having tracks are also contemplated within the present context. For example, in other examples, the track chain assembly 108 can be included in a conveyor system, as a track for transmitting torque between rotating elements, or in any other application known to those skilled in the art. Additionally, machines without tracks may include components, such as the cutting edge 120, as disclosed herein.

According to examples of the disclosure, various components of the machine 100 and its track chain assembly 108, such as the track shoes 118 and/or the cutting edges 120, may be formed in manner that improves their wear resistance, while maintaining and/or improving their overall toughness. The mechanisms as disclosed herein may apply to any variety of the track chain assembly components disclosed herein, to increase the hardness of those components. Additionally, the hardness of the components, such as the track shoes 118 and/or the cutting edges 120, may be improved without expensive, time-consuming, and/or energy intensive additional heat treatment processes. The processes described herein, along with the resulting components of the track-type machine 100 may result in components that have improved surface wear resistance, reduced galling between parts, and/or high toughness.

According to examples of the disclosure, the components of the track chain assembly 108, as well as the cutting edges 120 may be formed by hot-rolling steel to rough form the components and subsequently air-cooling, such as with a controlled cooling rate, to form the components described here, such as the track shoes 118 and/or the cutting edge 120. Although the disclosure discusses hot-rolled steel components, it should be understood that the rough components may be formed by any variety of suitable mechanisms, such as hot-forging, hot-extrusion, mold casting, continuous casting, etc. According to examples of the disclosure, additional metal working processes, such as shearing and/or punching, may be performed while the hot-rolled components are being air-cooled, such as in a controlled cool-down. In this way, the components may be machined while they are relatively softer than their final state at room temperature. When the components are air-cooled according to the mechanisms disclosed herein, those components may achieve a relatively high level of hardness by the time they cool down to room temperature, at which point it may be difficult to machine the components. Thus, according to examples of the disclosure, the components are machined during the controlled cool-down of the rough components.

When the components are air-cooled in a controlled manner, as disclosed herein, the final component, such as track shoe 118 and/or cutting edge 120, may include bainite crystal structure in the steel. Bainite crystal structure and/or bainitic crystal structure, as used herein, refers to any suitable type of bainite structure, including any suitable constituent micro-structure, including, but not limited to, dislocation-rich ferrite, cementite, and/or the like. In some cases, the component may include 5% or more bainite crystal structure, with the balance of martensite crystal structure and some austenite crystal structure. In other cases, and depending on the rate of cooling, the geometry of the component, etc., the component may include 60% or more bainite. In yet other cases, the component may include 80% or more bainite. In some cases, the components, such as the track shoes 118, may include about 0% to about 20% retained austenite crystal structure. In some cases, the components, such as the track shoes 118, may include about 5% to about 10% retained austenite crystal structure.

In some examples, the bainite content in the component may be substantially uniform throughout. In other cases, the martensite content may be greater near the outer surfaces of the component and less within the bulk of the component. For example, the portions of the components near the outer surface may have a greater percentage of martensite crystal structure, while the inner portions of the component may have a greater percentage of bainite. In this way, the components may display advantageous properties of greater hardness on its outer portions, with a softer core, resulting in greater toughness of the component.

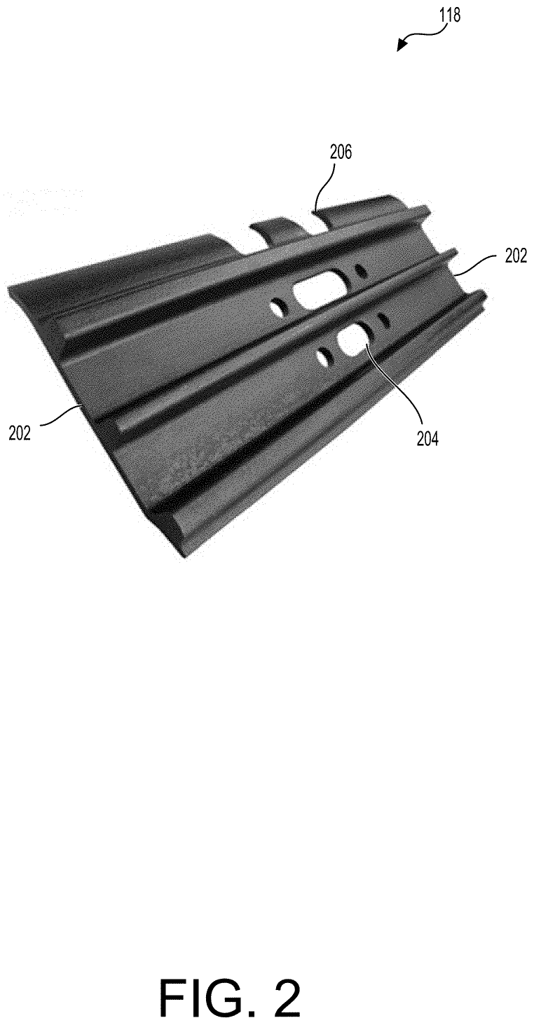

FIG. 2 is a schematic illustration of track shoe 118 of a track chain assembly for an undercarriage 102 of the example machine 100 as depicted in FIG. 1, according to examples of the disclosure. The track shoe 118 may include a variety of edges 202 and/or punchouts as defined by edges 204, 206. In some aspects, the present disclosure relates to the formation, production, and/or manufacture of components of the track chain assembly 108, such as the track shoe 118. Additionally, the mechanisms for formation of the track shoe 118 may be applied to other components of other machinery and/or other parts of the machine 100.

The track shoe 118 may be rough formed by a hot-rolling mechanism, where steel, such as in the form of billets, slabs, and/or any other suitable starting form, may be heated and rolled between rollers (e.g., a top roller and a bottom roller) to achieve the shape of the final track shoe 118. The steel may be rolled in a continuous manner to form long pieces of steel that can then be sheared to form the track shoes 118. For example, the multiple track shoes may be formed end-to-end and separated by a shearing process to form the edges 202. Additionally, the holes or punchouts may be formed, such as punchouts defined by edges 204, 206.

In the hot-rolling mechanism, the starting steel material may be heated to a relatively high temperature, such as austenitizing temperature. This temperature may be above about 800° C. At these temperatures, the steel may change its crystal structure based at least in part on its content and/or chemistry and subsequent thermal profiles. For example, the steel may be heated to between about 1100° C. and about 1350° C. In some cases, the steel may be heated to between about 1150° C. and about 1250° C. As a non-limiting example, the steel may be heated to about 1200° C. during the hot-rolling process to form the rough components. Although the disclosure describes the processes herein in the context of hot-rolling, it should be understood that the components may be roughly formed by any other suitable heated process, such as hot forging, hot extrusion, mold casting, continuous casting, or the like.

The steel used to form the rough track shoe may be of any suitable type and may include any suitable additives and/or impurities therein. For example, the steel used to hot roll the rough track shoes may include iron (Fe) with a variety of additives and/or impurities therein, such as carbon (C), boron (B), manganese (Mn), phosphorus (P), sulfur (S), silicon (Si), molybdenum (Mo), chromium (Cr), vanadium (V), and/or other materials. In some cases, the concentration of additives and/or impurities may be relatively uniform throughout. In other cases, the concentration of the additives and/or impurities may be non-uniform throughout the steel. For example, the outer portions of the steel components, such as the track shoes 118, may be such that the outer portions of the components are harder than the inner portions of the components.

The carbon content of the steel and the final component, such as the track shoes 118, may be in the range of about 0.05% to about 0.7% by weight. In other examples the carbon content of the components, such as the track shoes 118, may be in the range of about 0.1% to about 0.4% carbon by weight. For example, the components may be formed from American Iron and Steel Institute (AISI) 15B30 steel with a carbon content within the range of about 0.27% and about 0.35% by weight. In alternative examples, the track shoes 118 may be made of higher carbon steel, such as steel with carbon content greater than 0.4% by weight.

The other additives and/or impurities of the steel may be of any suitable type and/or concentration. For example, the steel may include between approximately 0.1% and 2% Mn by weight, between approximately 0% and 0.1% P by weight, between approximately 0% and 0.1% S by weight, between approximately 0.1% and 2% Si by weight, between approximately 0% and 3% Cr by weight, and/or between approximately 0% and 0.5% Mo. In some cases, the Si content may be approximately 1.5% by weight and the Cr content may also be approximately 1.5% by weight. Other elements present in the steel may include, but is not limited to, boron (B), cobalt (Co), nickel (Ni), titanium (Ti), tungsten (W), niobium (Nb), vanadium (V), nitrogen (N), combinations thereof, or the like. In one example, the steel may have about 0.32% to about 0.36% C, about 1.3% to about 1.7% Si, about 1.3% to about 1.7% Mn, about 0.6% to about 0.8% Cr, about 0.15% to about 0.25% Mo, about 0.02% to about 0.03% S, about 0.05% to about 0.15% V, about 0% to about 0.04% Ti, and/or about 0.006% to about 0.012% N.

After rough forming the track shoes 118 and/or cutting edge 120 in a heated process (e.g., hot-rolling), the components may be subjected to air-cooling in a controlled manner. Cool air (or other gaseous composition) may be flowed over the surfaces of the track shoes 118 and/or cutting edges 120 to cool the track shoes 118 and/or cutting edges 120 in a controlled manner. The flow rates and/or the inlet temperature of the cooling air may be controlled to control the cooling rate of the track shoes 118 and/or cutting edges 120 such that a desired proportion of bainite crystal is formed in the final track shoes 118 and/or cutting edges 120. For example, the cooling rate of the steel may be controlled by controlling the velocity of a fan and/or blower used to blow the air on the track shoe 118, cutting edge 120, and/or other component being air-hardened. In some examples, the component may be cooled at a rate of approximately between about 1° C./second (° C./s) (or 60° C./minute (° C./min)) and about 6° C./s (or 360° C./min). In other examples, the component may be cooled at a rate of approximately between about 1.5° C./s (or 90° C./min) and about 3° C./s (or 180° C./min). In one example, the component may be cooled at a rate of 2° C./s (or 120° C./min).

Without this air-cooling process, the track shoes 118 and/or cutting edges 120 may cool in a manner that results in a relatively high proportion of pearlite and/or ferrite crystal structure, resulting in an inadequate hardness for the track shoes 118. Thus, such a track shoe 118 formed by this traditional mechanism, without sufficient air-cooling rate, may need to have a subsequent thermal hardening process to achieve a desired level hardness, such as by forming hard martensite crystal structure in the track shoe 118 and/or cutting edge 120. Such a thermal hardening process may involve heating the track shoe 118 and/or cutting edge 120 to an austentizing temperature (e.g., above about 800° C.) and then performing a quenching process in a salt bath, oil, water, or any suitable quenching fluid. However, such a thermal hardening process used in traditional processing of track shoes is energy intensive, time-consuming, environmentally damaging, and/or expensive. Additionally, the quenching process used in traditional mechanisms to harden the steel may introduce warping and/or other mechanisms that result in reduced dimensional control. Thus, the processes disclosed herein, with air-hardening, to manufacturing the track shoes 118, cutting edges 120, and/or other components are energy efficient, faster, environmentally cleaner, less distortion inducing, and/or less expensive than traditional mechanisms of manufacturing these components.

According to examples of the disclosure, the edges 202 and/or the punchouts defined by edges 204, 206 may be formed during the air-cooling process. In other words, the machining of the steel of the track shoes 118, according to examples of the disclosure, are performed while the steel is still hot, before the steel is transformed into martensite during the air-cooling process. The machining may include any suitable machining and/or metal forming process, such as shearing, punching, cutting, lathing, drilling, turning, milling, etc. As discussed herein, these processes may be performed using any suitable machine (e.g., lathe, punching systems, drills, shearing systems, laser cutting systems, water cutting systems, etc.) while the steel is still at elevated temperatures. For example, the edges 202 of the track shoe 118 may be formed by a shearing process while the track shoe 118 is being air-cooled. Similarly, holes defined by edges 204, 206 of the track shoe 118 may be formed by a punchout process while the track shoe 118 is being air-cooled.

In some examples of the disclosure, the machining of the component, such as the track shoe 118, may be performed at a temperature range of about 250° C. and about 1100° C. In other examples, the machining of the components may be at a temperature range of about 300° C. and about 400° C. For example, the components may be machined at a temperature of about 350° C. If the components are not machined at elevated temperatures during the air-cooling, then the final cooled component, such as track shoes 118, may be too hard to effectively machine after the air-cooling process is complete. Thus, by machining during the air-cooling process, the component, such as track shoe 118, is advantageously machined while it is still relatively soft before complete hardening by the air-cooling process.

In some examples, a tempering process may be performed after the air-hardening process. In examples, the tempering process may be conducted at an under the carbon-steel eutectoid temperature for multiple hours after forming the track shoe 118 and/or other component. During the tempering process, the steel may be held at a temperature range of about 150° C. to about 350° C. for any suitable amount of time. For example, the track shoe 118 and/or any other component may be held at 200° C. for 3 hours to temper the steel. The temperature and/or time ranges here, and throughout the disclosure, are examples, and temperatures lower and higher and time periods shorter or longer may be used in accordance with examples of the disclosure.

The track shoe 118 steel, prior to hot-rolling and air-hardening, may be any suitable crystal structure, such as ferrite, pearlite, cementite, martensite, and/or austenite. The initial low or medium carbon steel may be relatively soft and ductile. For example, the steel may have an initial hardness lower than about 35 Rockwell Hardness Scale C (HRC). After the air-hardening and machining processes, as disclosed herein, the track shoes 118 may have a hardness in the range of about 40 HRC to about 55 HRC. In some cases, the finished track shoes 118 may have a hardness in the range of about 45 HRC to about 50 HRC. Additionally, the track shoes 118 may have Charpy impact toughness (V-notch) in the range of about 20 Joules (J) to about 80 J, using a 10 millimeter (mm)×10 mm Charpy V-notch sample per American Society for Testing and Materials (ASTM) E23. In some cases, the track shoes 118 may have Charpy impact toughness in the range of about 40 J to about 60 J. As a non-limiting example, the hot-machining processes during the air-hardening process may result in track shoes 118 with 46 HRC hardness and 45 J impact toughness.

In some examples, the heated machining during air-cooling, as described herein, may result in detectible striations or metal flow lines on the edges 202, 204, 206 of the track shoes. Additionally, in some cases, the heated machining during air-cooling may result in detectability of a greater martensite crystal structure concentration proximate to the edges 202, 204, 206 relative to regions that are more distal from the edges 202, 204, 206 (e.g., bulk portions of the track shoe 118). It should be understood that the mechanisms disclosed herein allow for the track shoes 118 and/or other components to be manufactured with desired levels of hardness and with fewer processing steps than traditional processes.

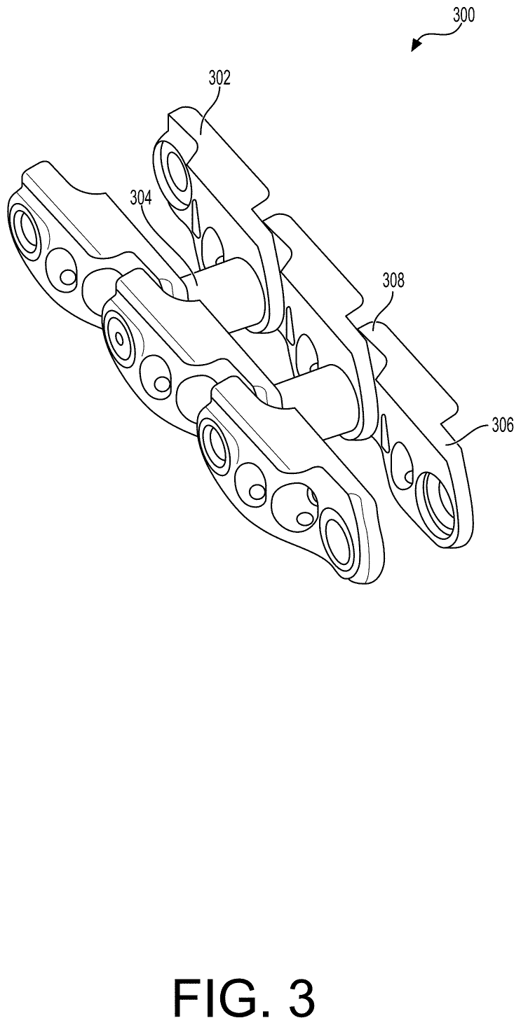

FIG. 3 is a schematic illustration of an example portion 300 of a track chain assembly 108 for an undercarriage of the example machine 100 as depicted in FIG. 1, according to examples of the disclosure. As discussed above, when operated, a drive sprocket 110 of the track-type machine 100 may rotate the track assembly 108 around one or more idlers or other guiding components, such as the front idler 112, a rear idler 114, and a plurality of track rollers 116, to facilitate movement of the track shoes 118, and therefore, the machine 100.

The track assembly 108 may further include a series of links 302 that may be joined to each other by laterally disposed track bushings 304. As shown, the links 302 may be offset links. That is, each of the links 302 may have an inwardly offset end 306 and an outwardly offset end 308. The inwardly offset end 306 of each of the links 302 are joined to the respective outwardly offset end 308 of each of the adjacent links. In addition, the inwardly offset end 306 of each of the links 302 may be joined to the inwardly offset end 306 of the opposing link, and the outwardly offset end 308 of each of the links 302 may be joined to the outwardly offset end 308 of the opposing link by the track bushing 304. It should be understood, however, that links 302 need not be offset links. Rather, in some examples, the links 302 may include inner links and outer links. In these examples, both ends of each opposing pair of inner links are positioned between ends of opposing outer links, as is known in the art.

In some aspects, at least part of the present disclosure relates to the formation, production, and/or manufacture of components of the track chain assembly 108, such as the track shoes 118, the track bushing 304, the drive sprocket 110, the front idler 112, the rear idler 114, the track roller 116, the link 302, and/or other components of the machine 100. Additionally, the mechanisms for formation of the components of the track chain assembly 108 be applied to other components of other machinery (including non-track type machines) and/or other parts of the machine 100.

The various components 110, 112, 114, 116, 302, 304 may be rough formed by any suitable process, such as hot-rolling, mold casting, extrusion, forging, etc. The steel used to form these components 110, 112, 114, 116, 302, 304 may be the same or similar to the steel discussed in conjunction with the track shoe 118 of FIG. 2. The processes (e.g., air-hardening, machining during air-hardening, post-formation tempering, etc.) may be the same or similar to the processes discussed with respect to the track shoes 118, as discussed in conjunction with FIG. 2. In some cases, the processes may be adjusted based on the geometry and/or dimensions of the components being processed and/or manufactured. The final properties (e.g., hardness, impact toughness, fracture toughness, wear-resistance, etc.) may be the same or similar to the track shoes 118, as discussed in conjunction with FIG. 2.

As discussed herein, the formation and/or manufacturing of the various components 110, 112, 114, 116, 118, 302, 304 according to mechanisms discussed herein result in various improvements in the parts themselves (e.g., reduced distortions, robust dimensional controls, etc.), as well as process and/or environments advantages (e.g., reduced energy use, increased environmental sustainability, reduced cost, reduced process times, etc.).

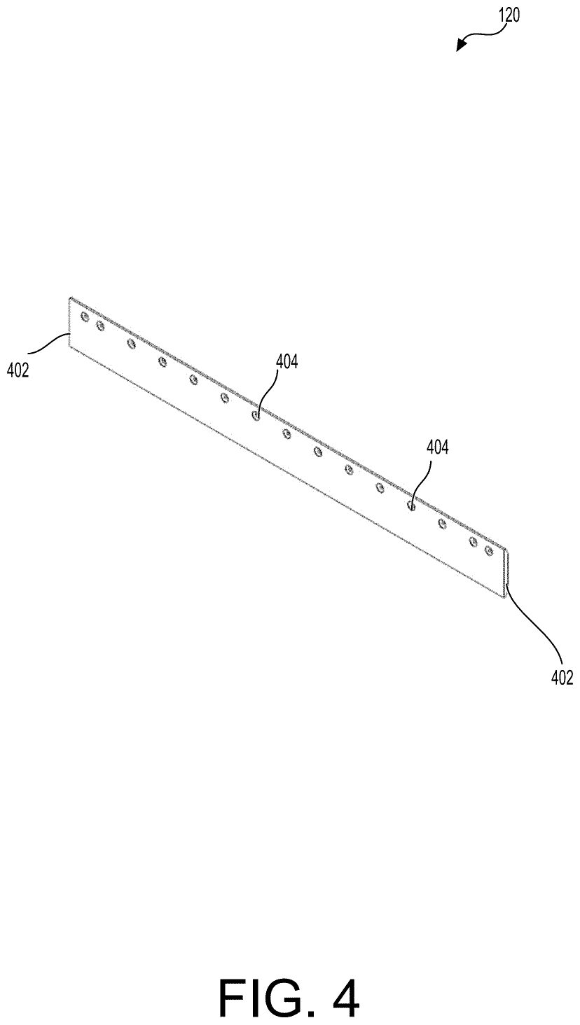

FIG. 4 is a schematic illustration of an example cutting edge 120 associated with the example machine 100 depicted in FIG. 1, according to examples of the disclosure. The cutting edge 120 and/or other ground-engaging tools may include a variety of edges 402 and/or holes as defined by edges 404. Similar to the track shoes 118, the cutting edge 120 may be rough formed by a hot-rolling mechanism, where steel, such as in the form of billets, slabs, and/or any other suitable starting form, may be heated and rolled between rollers (e.g., a top roller and a bottom roller) to achieve the shape of the final cutting edge 120. The steel may be rolled in a continuous manner to form long pieces of steel that can then be sheared to form the cutting edge 120. For example, the multiple cutting edges 120 may be formed end-to-end and separated by a shearing process to form the edges 402. Additionally, the holes or punchouts may be formed, such as punchouts defined by edges 404. Although the disclosure describes the processes herein in the context of hot-rolling, it should be understood that the components may be roughly formed by any other suitable heated process, such as hot forging, hot extrusion, mold casting, continuous casting, or the like.

The steel used to form the rough cutting edge may be of any suitable type and may include any suitable additives and/or impurities therein. In some cases, the concentration of additives and/or impurities may be relatively uniform throughout. In other cases, the concentration of the additives and/or impurities may be non-uniform throughout the steel. For example, the outer portions of the steel components, such as the cutting edge 120, may be such that the outer portions of the components are harder than the inner portions of the components.

The carbon content of the steel and the final component, such as the cutting edge 120, may be in the range of about 0.05% to about 0.7% by weight. In other examples the carbon content of the components, such as the cutting edge 120, may be in the range of about 0.1% to about 0.4% carbon by weight. For example, the components may be formed from AISI 15B30 steel with a carbon content within the range of about 0.27% and about 0.35% by weight. In alternative examples, the cutting edge 120 may be made of higher carbon steel, such as steel with carbon content greater than 0.4% by weight.

The other additives and/or impurities of the steel may be of any suitable type and/or concentration. For example, the steel may include between approximately 0.1% and 2% Mn by weight, between approximately 0% and 0.1% P by weight, between approximately 0% and 0.1% S by weight, between approximately 0.1% and 2% Si by weight, between approximately 0% and 3% Cr by weight, and/or between approximately 0% and 0.5% Mo. In some cases, the Si content may be approximately 1.5% by weight and the Cr content may also be approximately 1.5% by weight. Other elements present in the steel may include, but is not limited to, boron (B), cobalt (Co), nickel (Ni), titanium (Ti), tungsten (W), niobium (Nb), vanadium (V), nitrogen (N), combinations thereof, or the like. In one example, the steel may have about 0.32% to about 0.36% C, about 1.3% to about 1.7% Si, about 1.3% to about 1.7% Mn, about 0.6% to about 0.8% Cr, about 0.15% to about 0.25% Mo, about 0.02% to about 0.03% S, about 0.05% to about 0.15% V, about 0% to about 0.04% Ti, and/or about 0.006% to about 0.012% N.

After rough forming the cutting edge 120 in a heated process (e.g., hot-rolling), the components may be subjected to air-cooling in a controlled manner. Cool air (or other gaseous composition) may be flowed over the surfaces of the cutting edge 120 to cool the cutting edge 120 in a controlled manner. In some examples, the cutting edge 120 may be cooled at a rate of approximately between about 1° C./second (° C./s) (or 60° C./minute (° C./min)) and about 6° C./s (or 360° C./min). In other examples, the cutting edge 120 may be cooled at a rate of approximately between about 1.5° C./s (or 90° C./min) and about 3° C./s (or 180° C./min). In one example, the cutting edge 120 may be cooled at a rate of 2° C./s (or 120° C./min).

According to examples of the disclosure, the edges 402 and/or the holes defined by edges 404 may be formed during the air-cooling process. In other words, the machining of the steel of the cutting edge 120, according to examples of the disclosure, are performed while the steel is still hot, before the steel is transformed into martensite during the air-cooling process. The machining may include any suitable machining and/or metal forming process, such as shearing, punching, cutting, lathing, drilling, turning, milling, etc. As discussed herein, these processes may be performed using any suitable machine (e.g., lathe, punching systems, drills, shearing systems, laser cutting systems, water cutting systems, etc.) while the steel is still at elevated temperatures. For example, the edges 402 of the cutting edge 120 may be formed by a shearing process while the cutting edge 120 is being air-cooled. Similarly, holes defined by edges 404 of the cutting edge 120 may be formed by a punchout process or drilling process while the cutting edge 120 is being air-cooled.

In some examples of the disclosure, the machining of the component, such as the cutting edge 120, may be performed at a temperature range of about 250° C. and about 1100° C. For example, the components may be machined at a temperature of about 800° C. In other examples, the machining of the components may be at a temperature range of about 300° C. and about 400° C. If the components are not machined at elevated temperatures during the air-cooling, then the final cooled component, such as cutting edge 120, may be too hard to effectively machine after the air-cooling process is complete. Thus, by machining during the air-cooling process, the component, such as cutting edge 120, is advantageously machined while it is still relatively soft before complete hardening by the air-cooling process.

In some examples, a tempering process may be performed after the air-hardening process. In examples, the tempering process may be conducted at an under the carbon-steel eutectoid temperature for multiple hours after forming the cutting edge 120 and/or other component. During the tempering process, the steel may be held at a temperature range of about 150° C. to about 350° C. for any suitable amount of time. The temperature and/or time ranges here, and throughout the disclosure, are examples, and temperatures may be lower or higher and time periods shorter or longer may be used in accordance with examples of the disclosure.

The cutting edge 120 steel, prior to hot-rolling and air-hardening, may be any suitable crystal structure, such as ferrite, pearlite, cementite, martensite, and/or austenite. The initial low or medium carbon steel may be relatively soft and ductile. For example, the steel may have an initial hardness lower than about 35 HRC. After the air-hardening and machining processes, as disclosed herein, the cutting edge 120 may have a hardness in the range of about 40 HRC to about 55 HRC. In some cases, the finished cutting edge 120 may have a hardness in the range of about 45 HRC to about 50 HRC. Additionally, the cutting edge 120 may have Charpy impact toughness (V-notch) in the range of about 20 J to about 80 J, using ASTM E23 test. In some cases, cutting edges 120 may have Charpy impact toughness in the range of about 40 J to about 60 J. As a non-limiting example, the hot-machining processes during the air-hardening process may result in cutting edge 120 with 46 HRC hardness and 45 J impact toughness.

In some examples, the heated machining during air-cooling, as described herein, may result in detectible striations or metal flow lines on the edges 402, 404 of the cutting edge 120. Additionally, in some cases, the heated machining during air-cooling may result in detectability of a greater martensite crystal structure concentration proximate to the edges 402, 404 relative to regions that are more distal from the edges 402, 404 (e.g., bulk portions of the cutting edge 120). It should be understood that the mechanisms disclosed herein allow for the cutting edge 120 to be manufactured with desired levels of hardness and with fewer processing steps than traditional processes.

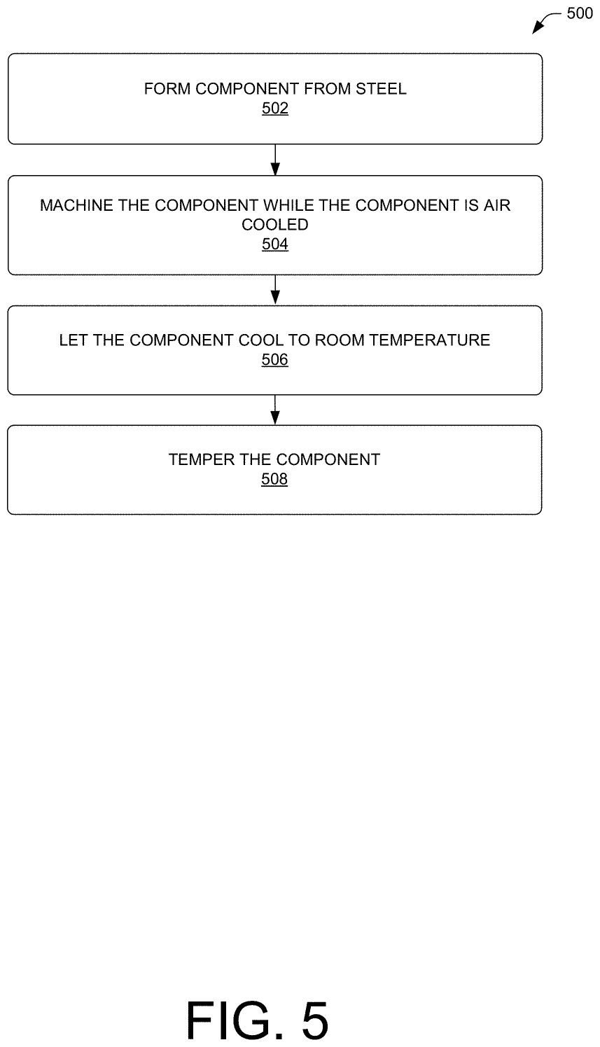

FIG. 5 is a flow diagram depicting an example method 500 for forming an example component of the machine 100 depicted in FIG. 1, according to examples of the disclosure. In some cases, the entirety of the method 500 may be performed at a steel mill, such as in an integrated manner. In other examples, some processes of method 500 may be performed in a steel mill and other processes may be performed in one or more other factories, such as a heavy machinery factory.

At block 502, the component is formed from steel. This may form the rough component, such as a rough component of the track shoes 118 and/or the cutting edge 120. The component may be formed by any suitable hot forming process, such as hot-rolling, mold casting, extrusion, forging, continuous casting, combinations thereof, or the like. In some cases, low-carbon or mid-carbon steel may be used to form the rough components. The carbon component of the steel may be in the range of about 0.05% to about 0.7% by weight. The steel may also include other additives and/or impurities. For example, the steel may include between approximately 0.1% and 2% Mn by weight, between approximately 0% and 0.1% P by weight, between approximately 0% and 0.1% S by weight, between approximately 0.1% and 2% Si by weight, between approximately 0.0% and 3% Cr by weight, and/or between approximately 0% and 0.5% Mo. In some cases, the Si content may be approximately 1.5% by weight and the Cr content may also be approximately 1.5% by weight. Other elements present in the steel may include, but is not limited to, boron (B), cobalt (Co), nickel (Ni), titanium (Ti), tungsten (W), niobium (Nb), vanadium (V), nitrogen (N), combinations thereof, or the like. In one example, the steel may have about 0.32% to about 0.36% C, about 1.3% to about 1.7% Si, about 1.3% to about 1.7% Mn, about 0.6% to about 0.8% Cr, about 0.15% to about 0.25% Mo, about 0.02% to about 0.03% S, about 0.05% to about 0.15% V, about 0% to about 0.04% Ti, and/or about 0.006% to about 0.012% N.

At block 504, the component may be machined while it is air-cooled. In this process, the component may be cooled (e.g., by convective cooling) by blowing air or other gases over the surface of the component, such as the track shoes 118. The air cooling may be controlled, in some examples. During the air-cooling, the components, such as the track shoes 118 may be machined, using any variety of processes and/or any suitable machinery. The machining may include any suitable machining process, such as shearing, punching, cutting, lathing, drilling, turning, milling, etc. As discussed herein, these processes may be performed using any suitable machine (e.g., lathe, punching systems, drills, shearing systems, laser cutting systems, water cutting systems, etc.) while the steel is still at elevated temperatures. For example, the edges 202 of the track shoe 118 may be formed by a shearing process while the track shoe 118 is being air-cooled. Similarly, holes defined by edges 204, 206 of the track shoe 118 may be formed by a punchout process while the track shoe 118 is being air-cooled. The edges 402 and holes 404 of the cutting edge 120 may be formed by similar mechanisms. In other examples, the machining of the components may be at a temperature range of about 300° C. and about 1100° C. In some cases, the components may be machined at a temperature range of about 300° C. and about 1100° C. For example, the components may be machined at a temperature of about 350° C. In other cases, the components may be machined at a temperature range of about 600° C. and about 1000° C. For example, the components may be machined at a temperature of about 800° C.

At block 506, the component may be allowed to cool to room temperature. In examples, the air-cooling is completed after the machining processes. This cooling may be continued until the track shoe or the other component reaches room temperature or approaches room temperature.

At block 508, the component is tempered. During the tempering process, or anneal process, the steel may be held at a temperature range of about 150° C. to about 350° C. for any suitable amount of time. For example, the track shoe 118, cutting edge 120, and/or any other component may be held at 225° C. for 2 hours to temper the steel. The temperature and/or time ranges here, and throughout the disclosure, are examples, and temperatures and time periods shorter or longer may be used in accordance with examples of the disclosure.

It should be noted that some of the operations of method 500 may be performed out of the order presented, with additional elements, and/or without some elements. Some of the operations of method 500 may further take place substantially concurrently and, therefore, may conclude in an order different from the order of operations shown above.

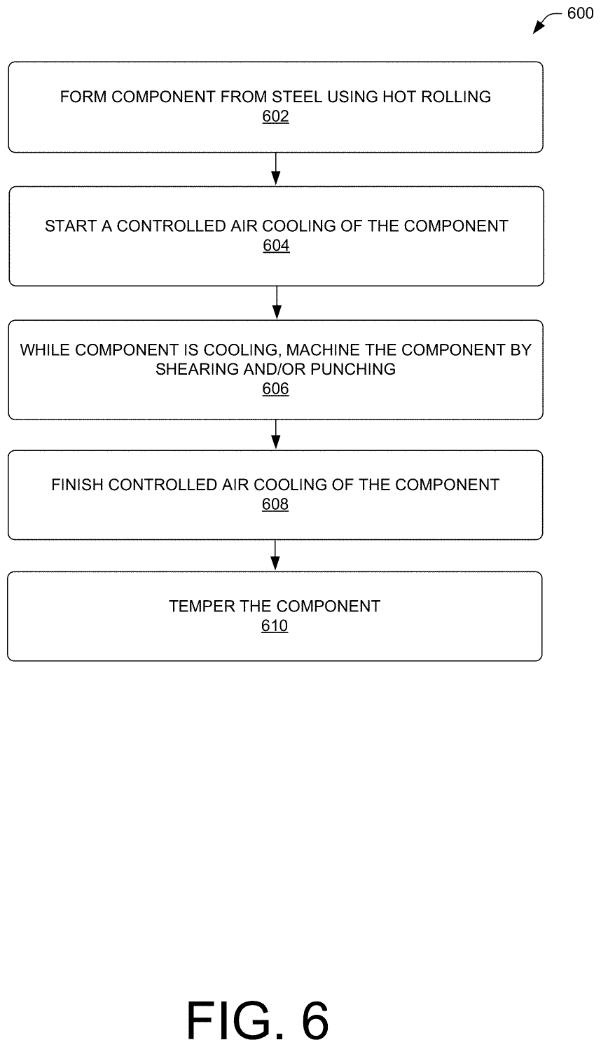

FIG. 6 is a flow diagram depicting another example method 500 for forming an example component of the machine 100 depicted in FIG. 1, according to examples of the disclosure. In some cases, the entirety of the method 600 may be performed at a steel mill, such as in an integrated manner. In other examples, some processes of method 600 may be performed in a steel mill and other processes may be performed in one or more other factories, such as a heavy machinery factory.

At block 602, the component may be formed from steel using hot-rolling. In the hot-rolling process, steel, such as heated steel billet may be rolled between one or more rollers (e.g., top and bottom rollers) to form a component, such as the track shoe 118 or the cutting edge 120. The rollers may have the inverse of the desired topography thereon and during the rolling process imparts the inverse of its topography to the component, such as the track shoe 118 or the cutting edge 120 being rolled. Alternatively, the component may be formed by other heated forming processes, as discussed herein.

In some cases, low-carbon or mid-carbon steel may be used to form the rough components. In alternative cases, high-carbon steel may be used. The carbon component of the steel may be in the range of about 0.05% to about 0.7% by weight. The steel may also include other additives and/or impurities. For example, the steel may include between approximately 0.1% and 2% Mn by weight, between approximately 0% and 0.1% P by weight, between approximately 0% and 0.1% S by weight, between approximately 0.1% and 2% Si by weight, between approximately 0% and 3% Cr by weight, and/or between approximately 0% and 0.5% Mo. In some cases, the Si content may be approximately 1.5% by weight and the Cr content may also be approximately 1.5% by weight. Other elements present in the steel may include, but is not limited to, boron (B), cobalt (Co), nickel (Ni), titanium (Ti), tungsten (W), niobium (Nb), vanadium (V), nitrogen (N), combinations thereof, or the like. In one example, the steel may have about 0.32% to about 0.36% C, about 1.3% to about 1.7% Si, about 1.3% to about 1.7% Mn, about 0.6% to about 0.8% Cr, about 0.15% to about 0.25% Mo, about 0.02% to about 0.03% S, about 0.05% to about 0.15% V, about 0% to about 0.04% Ti, and/or about 0.006% to about 0.012% N.

At block 604, a controlled air-cooling of the component may be started. Cool air (or other gaseous composition) may be flowed over the surfaces of the component, such as the track shoes 118 or cutting edge 120, to cool the component in a controlled manner. The flow rates and/or the inlet temperature of the cooling air may be controlled, such as by controlling a fan, blower, or flow valve (e.g., a throttle valve) to control the cooling rate of the component such that a desired proportion of bainite crystal is formed in the component. In some examples, the track shoes 118 may be cooled at a rate of approximately between about 1° C./second (° C./s) (or 60° C./minute (° C./min)) and about 6° C./s (or 360° C./min). In other examples, the track shoes 118 or other component may be cooled at a rate of approximately between about 1.5° C./s (or 90° C./min) and about 3° C./s (or 180° C./min). In one example, the track shoes 118 or other component may be cooled at a rate of 2° C./s (or 120° C./min).

At block 606, the component may be machined by shearing or punching, while the component is being cooled. The component may be machined at any suitable point during the air-cooling process. As discussed herein, these processes may be performed using any suitable machine (e.g., lathe, punching systems, drills, shearing systems, laser cutting systems, water cutting systems, etc.) while the steel is still at elevated temperatures. For example, the edges 402 of the cutting edge 120 may be formed by a shearing process while the cutting edge 120 is being air-cooled. Similarly, holes defined by edges 404 of the cutting edge 120 may be formed by a punchout process while the cutting edge 120 is being air-cooled. The edges 202, 204, 206 of the track shoes 118 may be formed by similar mechanism. In examples, the machining of the components may be at a temperature range of about 300° C. and about 1100° C. For example, the components may be machined at a temperature of about 350° C.

At block 608, the controlled air-cooling of the component may be finished. This process may be finished from the point when the machining of the component, such as the track shoe 118, is done. Completing this process may result in a relatively high concentration of bainite crystal structure in the finished component. After completing this process, the component, such as the track shoe 118, is relatively hard and have high impact toughness.

At block 610, the component may be tempered. During the tempering process, the steel may be held at a temperature range of about 150° C. to about 350° C. for any suitable amount of time. For example, the track shoe 118 and/or any other component may be held at 175° C. for 4 hours to temper the steel. The temperature and/or time ranges here, and throughout the disclosure, are examples, and temperatures lower and higher and time periods shorter or longer may be used in accordance with examples of the disclosure.

The completion of method 600 may result in a hardness in the range of about 40 HRC to about 55 HRC of the component. In some cases, the finished component may have a hardness in the range of about 45 HRC to about 50 HRC. Additionally, the component may have Charpy impact toughness (V-notch) in the range of about 20 Joules (J) to about 80 J, using a 10 millimeter (mm)×10 mm Charpy V-notch sample per ASTM E23. In some cases, the component may have Charpy impact toughness in the range of about 40 J to about 60 J. As a non-limiting example, the hot-machining processes during the air-hardening process may result in component with 46 HRC hardness and 45 J impact toughness.

It should be noted that some of the operations of method 600 may be performed out of the order presented, with additional elements, and/or without some elements. Some of the operations of method 600 may further take place substantially concurrently and, therefore, may conclude in an order different from the order of operations shown above.

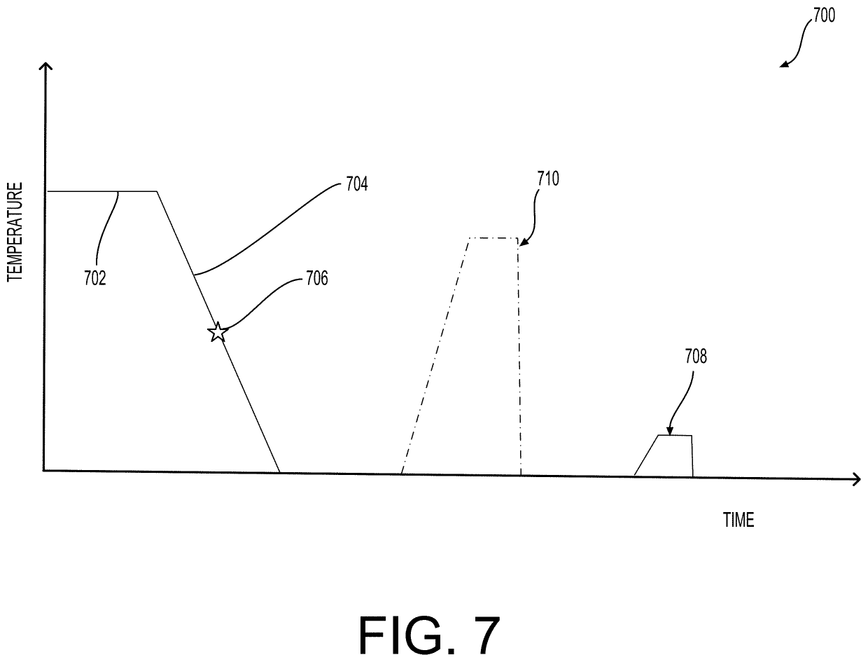

FIG. 7 is a chart 700 depicting a temperature profile for forming an example component of the machine 100 depicted in FIG. 1, according to examples of the disclosure. In some cases, the component may be the track shoe 118 or the cutting edge 120. In this chart, the y-axis represents temperature and the x-axis represents time. The region 702 represents the hot-rolling (or other hot forming process) for forming the rough track shoe 118 or other component. This region, as discussed herein may be at an austentizing temperature (e.g., over about 800° C.). For example, the temperature of region 702 may be in the range of about 1100° C. and about 1350° C.

The region 704 represents the air-cooling of the track shoe 118 or other component, according to the disclosure herein. The cooling rate may be controlled by controlling the mount of air (or other gas) blown over the track shoe 118 or other component. As discussed herein, the cooling rate may be in the range of about 1° C./second (° C./s) (or 60° C./minute (° C./min)) and about 6° C./s (or 360° C./min). In other examples, the track shoes 118 or other component may be cooled at a rate of approximately between about 1.5° C./s (or 90° C./min) and about 3° C./s (or 180° C./min). In one example, the track shoes 118 or other component may be cooled at a rate of 2° C./s (or 120° C./min).

The point 706 represents the point during the air-cooling where the track shoe 118 or other components are machined. For example, this point 706 may be where the track shoes 118 or other components are sheared, cut, punched, drilled, lathed, etc. The machining of the track shoe 118 or other components may be performed at a temperature range of about 250° C. and about 1100° C. For example, the machining of the track shoe 118 or other components may be at a temperature range of about 300° C. and about 400° C. For example, the track shoe 118 or other components may be machined at a temperature of about 350° C. In another example, the machining of the cutting edge 120 or other components may be at a temperature range of about 600° C. and about 1000° C. For example, the cutting edge 120 or other components may be machined at a temperature of about 800° C.

The region 708 represents a tempering process performed on the air-hardened track shoe 118 or other component. During the tempering process, the steel may be held at a temperature range of about 150° C. to about 350° C. for any suitable amount of time. For example, the track shoe 118 and/or any other component may be held at 250° C. for 100 minutes to temper the steel. The temperature and/or time ranges here, and throughout the disclosure, are examples, and temperatures lower or higher and time periods shorter or longer may be used in accordance with examples of the disclosure.

The region 710 is indicated here (in doted lines) to represent a thermal hardening process that is used in traditional processes, where the track shoe 118 or other component is heated to an elevated temperature and then quenched in a salt bath, oil, water, or any suitable fluid. As discussed herein, this thermal hardening process used in the traditional manufacture of track shoes and other components may be energy intensive, environmentally harmful, time-consuming, costly, and may induce warpage in the finished track shoes 118 or other components. As a result, by avoiding the thermal treatment represented by region 710, as embodied by the processes disclosed herein, the track shoes 118 or other components may be manufactured with reduced energy, cost, and time, and the process, may induce less dimensional distortion and may be easier to control.

### INDUSTRIAL APPLICABILITY

The present disclosure describes systems, structures, and methods to improve wear tolerance and toughness of components, such as components for track-type machines 100 or other machines. These improved components may include track shoes 118, cutting edges 120, bushings 304, and other components used in track chain assemblies 108 or other portions of machines 100. The components, such as the track shoes 118, as disclosed herein, may have desired hardness and impact toughness without performing a thermal process involving reheat and quench of the components. Thus, the components can be formed with low energy usage, low cost, reduced environmental impact, and/or low-distortion of the components. Although the components, such as the track shoes 118, and the procedures to form the components are discussed in the context of track-type machines 100 and undercarriages 102 of those track-type machines 100, it should be appreciated that the mechanisms to form the same are applicable across a wide array of mechanical systems, such as any mechanical system that can benefit from improved wear resistance of various components.

As a result of the systems, apparatus, and methods described herein, consumable parts of machines 100, such as track shoes 118 and/or cutting edges 120 may have a greater lifetime than they otherwise would. For example, the track shoes 118 described herein may have greater service lifetime than track shoes 118 that are not formed by the air-hardening mechanisms described herein. This reduces field downtime, reduces the frequency of servicing and maintenance, and overall reduces the cost of heavy equipment, such as machines 100. The improved reliability and reduced field-level downtime also improves the user experience, such that the machine 100 can be devoted to its intended purpose for longer times and for an overall greater percentage of its lifetime. Improved machine 100 uptime and reduced scheduled maintenance may allow for more efficient deployment of resources (e.g., fewer, but more reliable machines 100 at a construction site). Thus, the technologies disclosed herein improve the efficiency of project resources (e.g., construction resources, mining resources, etc.), provide greater uptime of project resources, and improve the financial performance of project resources.

While aspects of the present disclosure have been particularly shown and described with reference to the examples above, it will be understood by those skilled in the art that various additional examples may be contemplated by the modification of the disclosed machines, systems and methods without departing from the spirit and scope of what is disclosed. Such examples should be understood to fall within the scope of the present disclosure as determined based upon the claims and any equivalents thereof.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein.

What is claimed is:

1. A method of manufacturing a machine component, comprising:
forming the machine component using steel heated to a temperature greater than 800° C.;
cooling the machine component by directing air onto the machine component to form at least 5% bainite crystal structure in the machine component; and
machining the machine component while cooling the machine component.

2. The method of claim 1, wherein the steel comprises:
carbon in a range of approximately 0.2% and approximately 0.4% by weight;
manganese in a range of approximately 0.1% and approximately 2% by weight; and
silicon in a range of approximately 0.1% and 2 approximately % by weight.

3. The method of claim 1, wherein forming the machine component comprises hot-rolling the machine component.

4. The method of claim 1, wherein the machine component comprises at least one of a track shoe or a cutting edge.

5. The method of claim 1, wherein machining the machine component comprises at least one of shearing the machine component or punching the machine component.

6. The method of claim 1, wherein the machine component, after cooling the machine component, comprises at least approximately 5% bainite crystal structure.

7. The method of claim 1, wherein the machine component comprises a hardness in a range of 40 HRC to 55 HRC.

8. The method of claim 1, wherein the machine component comprises a Charpy impact toughness in a range of 20 J to 80 J.

9. The method of claim 1, wherein cooling the machine component comprises cooling the machine component with a rate in a range of approximately 1° C./s to approximately 6° C./s.

10. The method of claim 1, wherein machining the machine component comprises machining the machine component at a temperature in a range of approximately 300° C. to approximately 1100° C.

11. A machine, comprising:
at least one component including at least one of a track shoe or a cutting edge, the at least one component including:
a first surface and a second surface opposing the first surface;
a first edge defining a first end of the at least one component, the first end extending from the first surface to the second surface;
a second edge defining a second end of the at least one component, the second end opposing the first end, the second end extending from the first surface to the second surface; and
a third edge that defines a punchout hole extending from the first surface to the second surface, wherein the at least one component comprises at least approximately 5% bainite crystal structure and a hardness in a range of 40 HRC to 55 HRC.

12. The machine of claim 11, wherein the first edge comprises striations resulting from machining the at least one component.

13. The machine of claim 11, further comprising a bainite crystal structure of at least 40%.

14. The machine of claim 11, further comprising an austenite crystal structure in a range of 5% to 10%.

15. The machine of claim 11, further comprising a Charpy impact toughness in a range of 20 J to 80 J.

16. A track chain assembly, comprising:
a plurality of track shoes;
a plurality of links; and
a plurality of bushings, wherein at least one of the plurality of track shoes, the plurality of links, and the plurality of bushings is formed by:
hot-rolling steel, the steel having carbon in a range of approximately 0.2% and approximately 0.4% by weight, manganese in a range of approximately 0.1% and approximately 2% by weight, and silicon in a range of approximately 0.1% and approximately 2% by weight;
air-cooling the at least one of the plurality of track shoes, the plurality of links, and the plurality of bushings for a period of time; and
machining the at least one of the plurality of track shoes, the plurality of links, and the plurality of bushings, during the period of time and at a temperature in a range of approximately 300° C. and approximately 1100° C.

17. The track chain assembly of claim 16, wherein the at least one of the plurality of track shoes, the plurality of links, and the plurality of bushings is manufactured further by tempering the at least one of the plurality of track shoes, the plurality of links, and the plurality of bushings at a temperature in the range of approximately 150° C. and approximately 350° C.

18. The track chain assembly of claim 16, wherein air-cooling of the at least one of the plurality of track shoes, the plurality of links, and the plurality of bushings comprises air-cooling the plurality of track shoes, the plurality of links, and the plurality of bushings with a rate in a range of approximately 1° C./s to approximately 6° C./s.

19. The track chain assembly of claim 16, wherein the at least one of the at least one of the plurality of track shoes, the plurality of links, and the plurality of bushings comprises a hardness in a range of 40 HRC to 55 HRC.

20. The track chain assembly of claim 16, wherein the at least one of the at least one of the plurality of track shoes, the plurality of links, and the plurality of bushings comprises a Charpy impact toughness in a range of 20 J to 80 J.
